(19) United States
(12) Patent Application Publication
(10) Pub. No.: US 2008/0007669 A1
(43) Pub. Date: Jan. 10, 2008

(54) Fabricating method for liquid crystal device and system for displaying image

(75) Inventor: Chun-Yen Chi, Taichung County (TW)

Correspondence Address: BIRCH STEWART KOLASCH & BIRCH, PO BOX 747, FALLS CHURCH, VA, 22040-0747, US

(73) Assignee: TPO DISPLAYS CORP.

(21) Appl. No.: 11/819,999

(22) Filed: Jun. 29, 2007

(30) Foreign Application Priority Data
Jul. 5, 2006 (TW) 095124550

(51) Int. Cl. G02F 1/1333

(52) U.S. Cl. 349/58

(57) ABSTRACT

A system for displaying an image includes a backlight module, a liquid crystal display (LCD) panel and a frame. The LCD panel is combined with the backlight module and has a first side and a second side opposite to each other. The frame has a first elastic member. The LCD panel is disposed in the frame, and the first side and the second side of the LCD panel respectively contact the first elastic member and the frame. A method of fabricating a liquid crystal display is also disclosed.

### BACKGROUND OF THE INVENTION

1. Field of Invention

The invention relates to a fabricating method and a system, and, in particular, to a fabricating method of a liquid crystal display and a system for displaying an image.

2. Related Art

A liquid crystal display is mainly composed of a LCD (Liquid Crystal Display) panel and a backlight module, which provides a light source to enable the LCD panel to display an image.

Referring to FIG. 1, a conventional liquid crystal display 1 has a backlight module 11 and a LCD panel 12. The backlight module 11 has a light source 111, a light guide plate 112, a plurality of optical films 114 to 116 and a frame 113. The light source 111, the light guide plate 112 and the plurality of optical films 114 to 116 are disposed in the frame 113. The backlight module 11 in the drawing is an edge lighting backlight module. Of course, the backlight module 11 may also be a bottom lighting backlight module. In addition, the light source 111 in the drawing is a LED (Light Emitting Diode). Of course, the light source 111 may also include cold cathode fluorescent lamps (CCFL) or cold cathode flat fluorescent lamps (CCFFL).

The optical films 114 to 116 are respectively classified into a reflector 114, a diffuser 115 and a brightness enhancement film 116 according to the functions thereof. The reflector 114 guides the scattered light rays of the light source 111 into the light guide plate 112. The diffuser 115 uniformly diffuses the light rays of the light source 111 by way of diffusion and reflection. The brightness enhancement film 116 gathers the light rays of the light source 111 and enhances the brightness. If the liquid crystal display 1 has a small size, the backlight module 11 often pertains to the edge lighting backlight module, and the light source thereof is usually disposed at an edge of the backlight module 11 or the frame 113 so as to reduce the thickness of the backlight module 11.

In addition, the LCD panel 12 has a thin film transistor substrate 121 and a color filter 122. Usually, one side of the thin film transistor substrate 121 of the LCD panel 12 is disposed on the backlight module 11. The prior art usually adheres a double-coated adhesive 13 to one side of the backlight module 11 and then places the LCD panel 12 on the backlight module 11 in order to assemble the backlight module 11 with the LCD panel 12. The double-coated adhesive 13 can adhere the backlight module 11 to the LCD panel 12.

However, the process of adhering the double-coated adhesive 13 is usually performed manually, and the operator has to carefully and precisely adhere the LCD panel 12 to the backlight module 11 and prevent the LCD panel 12 from skew, so the assembling process is complicated.

In addition, if the LCD panel 12 is not well aligned, the LCD panel 12 has to be peeled off the backlight module 11 and the double-coated adhesive 13 has to be disposed on the frame 113 again such that the backlight module 11 and the LCD panel 12 can be assembled together. Because the double-coated adhesive 13 for assembly has the strong adhesive force, the LCD panel 12 cannot be peeled off the backlight module 11 unless a destructive disassembly is performed. In addition, if the separating force is not well applied, the backlight module 11 or the LCD panel 12 may be damaged, or the residual adhesive of the double-coated adhesive 13 still remains on the backlight module 11 or the LCD panel 12. Thus, the LCD panel 12 with the residual adhesive cannot be treated as a new product or a good product for rework, so the cost is increased.

It is therefore an important subject to provide a method of fabricating a liquid crystal display and an image displaying system, which can solve the above mentioned problems.

### SUMMARY OF THE INVENTION

In view of the foregoing, the invention is to provide a method of fabricating a liquid crystal display and an image displaying system, in which the liquid crystal display can be assembled in a non-destructive manner.

To achieve the above, an image displaying system according to the invention includes a backlight module, a LCD panel and a frame. The LCD panel is combined with the backlight module, and has a first side and a second side opposite each other. The frame has a first elastic member. The LCD panel is disposed in the frame, and the first side and the second side respectively contact the first elastic member and the frame.

To achieve the above, the invention also discloses a method of fabricating a liquid crystal display. The method includes the steps of providing a backlight module, a LCD (Liquid Crystal Display) panel and a frame, wherein the backlight module is combined with the LCD panel, the LCD panel has a first side and a second side opposite to each other, and the frame has a first elastic member; pushing the LCD panel to make the first elastic member contact the first side of the LCD panel to produce an elastic force; and placing the LCD panel in the frame for enabling the elastic force of the first elastic member to push the LCD panel to make the second side of the LCD panel contact the frame.

As mentioned above, because the first elastic members are disposed on the frame in the image displaying system and due to the disclosed method of fabricating the liquid crystal display according to the invention, the LCD panel can be disposed in the frame by pushing against the first elastic members or be removed from the frame by pushing the elastic members. Thus, the LCD panel may be disposed in the frame or removed from the frame in a nondestructive manner so that the problem of damaging the LCD panel when it is disassembled from the frame can be avoided. The disassembled LCD panel may also be treated as a new product or a good product for rework, such that the cost of assembling the LCD panel with the backlight module can be reduced.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional liquid crystal display;

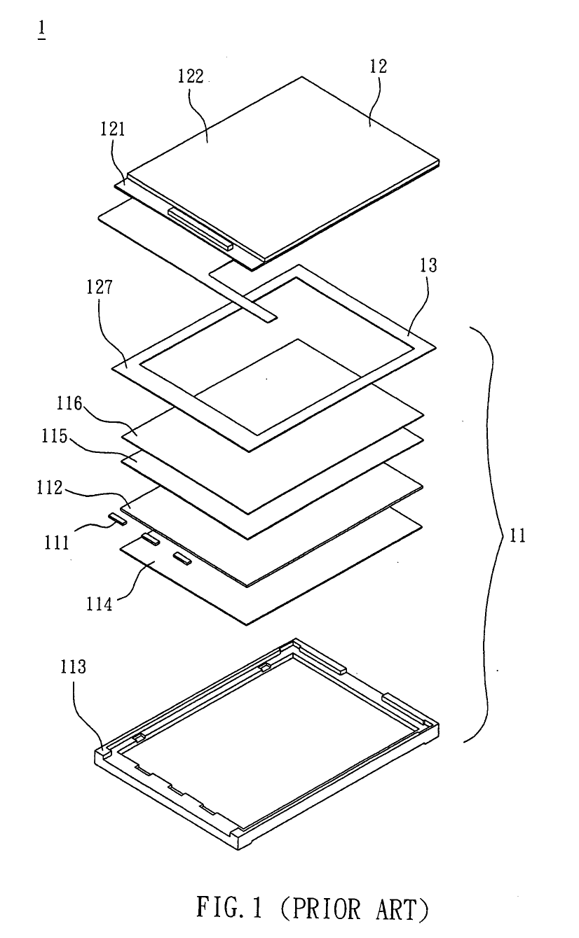

FIG. 2A is a pictorially exploded view showing an image display system according to a preferred embodiment of the invention;

FIG. 2B is another pictorially exploded view showing the image displaying system according to the preferred embodiment of the invention;

FIG. 3 is flow chart showing a method of assembling the liquid crystal display according to the preferred embodiment of the invention;

FIG. 4A is a pictorial view showing the assembled image displaying system according to the preferred embodiment of the invention;

FIG. 4B is a top view showing the assembled image displaying system of FIG. 4A; and

FIG. 5 is a block diagram showing the image displaying system according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

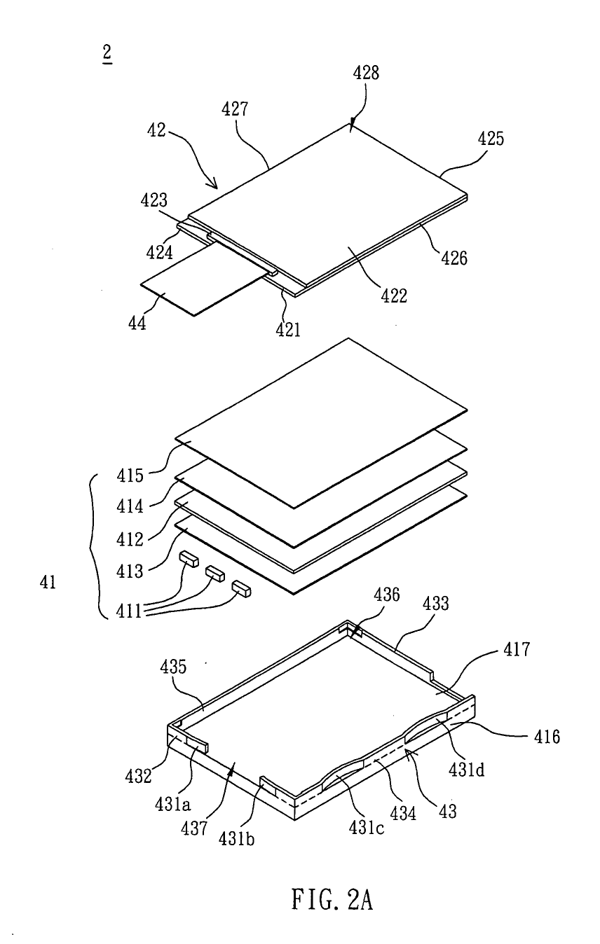

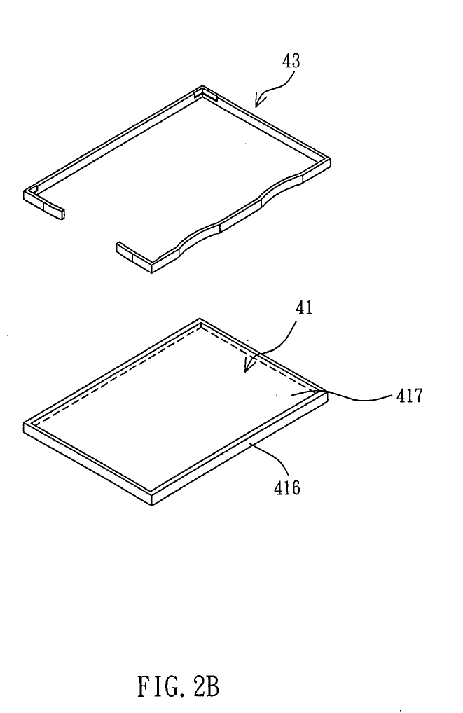

FIG. 2A is a pictorially exploded view showing an image displaying system 2 according to a preferred embodiment of the invention. Referring to FIG. 2A, the image displaying system 2 includes a backlight module 41, a LCD (Liquid Crystal Display) panel 42 and a frame 43. The backlight module 41, the LCD panel 42 and the frame 43 may be assembled together to form a liquid crystal display. The backlight module 41 supplies sufficient and uniformly distributed light rays, and may be an edge lighting backlight module or a bottom lighting backlight module. In this embodiment, the backlight module 41 is the edge lighting backlight module. The backlight module 41 usually has a light source 411, a light guide plate 412 and a plurality of optical films 413 to 415. The light source 411 may be a cold cathode fluorescent lamp or a light emitting diode (LED). In this embodiment, the light source 411 is a light emitting diode (LED). The light guide plate 412 guides the light source 411 uniformly into a plane light source. The optical films 413 to 415 are classified as a reflector 413, a diffuser 414 and a brightness enhancement film 415 according to their respective functions. The reflector 413 guides the scattered light rays of the light source 411 into the light guide plate 412 again. The diffuser 414 diffuses the light rays of the light source 411 uniformly by way of diffusion and reflection. The brightness enhancement film 415 gathers the light rays of the light source 411 to enhance the brightness.

It is to be specified that the backlight module 41 further has an outer frame 416 and a base 417. The base 417 can be omitted in different designs. In this embodiment, the outer frame 416, the base 417 and the frame 43 are integrally formed. The elements of the backlight module 41, such as the light source 411, the light guide plate 412, the optical films 413 to 415, may be directly disposed in the outer frame 416 and disposed above the base 417. Generally speaking, the frame 43 and the outer frame 416 and the base 417 of the backlight module 41 can be integrally formed by way of plastic injection molding. However, the outer frame 416 and the base 417 of the backlight module 41 and the frame 43 are not particularly limited to be formed integrally in this invention. In addition, as shown in FIG. 2B, the outer frame 416 and the base 417 of the backlight module 41 and the frame 43 are not integrally formed. It is also possible to manufacture the backlight module 41 and the frame 43, and then to adhere the backlight module 41 to one side of the frame 43.

As shown in FIG. 2A, the LCD panel 42 is disposed adjacent to the backlight module 41 and has a first side 424 and a second side 425 opposite to each other. The LCD panel 42 usually includes a thin film transistor substrate 421, a color filter 422 and a connection end 423. The connection end 423 connects the thin film transistor substrate 421 to a flexible cable 44, which is electrically connected to the LCD panel 42 and may pass through a notch 437 of the frame 43. The flexible cable 44 may transfer the power and signals to the LCD panel 42 to control a liquid crystal array on the thin film transistor substrate 421. The color display of the LCD panel 42 has to utilize the backlight module 41, which provides the light source, to make the light rays pass through the liquid crystal and the color filter 422 to form the color picture.

In addition, the LCD panel 42 has a third side 426 and a fourth side 427 opposite to each other. The first side 424, the second side 425, the third side 426 and the fourth side 427 of the LCD panel 42 are connected sequentially, and the angle between the second side 425 and the fourth side 427 serves as a first positioning angle 428 to facilitate the assembly.

The frame 43 has first elastic members 431a and 431b, the LCD panel 42 is disposed in the frame 43, and the first side 424 and the second side 425 respectively contact the first elastic members 431a and 431b and the frame 43. In this embodiment, the frame 43 further has a first sidewall 432 and a second sidewall 433 opposite to each other. The first sidewall 432 has the notch 437, and the first elastic members 431a and 431b are disposed on the first sidewall 432 and close to two sides of the notch 437.

In addition, the frame 43 further has a third sidewall 434 and a fourth sidewall 435 opposite to each other. The first sidewall 432, the third sidewall 434, the second sidewall 433 and the fourth sidewall 435 of the frame 43 are connected sequentially, and a second positioning angle 436 is formed between the second sidewall 433 and the fourth sidewall 435. In addition, the frame 43 has two second elastic members 431c and 431d, which are disposed on the third sidewall 434. Consequently, the third side 426 and the fourth side 427 of the LCD panel 42 respectively contact the second elastic members 431c, 431d and the fourth sidewall 435 of the frame 43.

In this embodiment, the frame 43 has four elastic members 431a, 431b, 431c and 431d, each of which has the thickness of about 2 mm, wherein the first elastic members 431a and 431b are flexible arms and respectively disposed close to the two sides of the notch 437. The second elastic members 431c and 431d have slightly arched shapes or the slightly rib-like shapes, and are disposed on the third sidewall 434.

The number of the first elastic members or the second elastic members may be determined according to the size of the LCD panel. If the LCD panel is larger, more first elastic members or second elastic members may be disposed on the frame. In addition, a plurality of first or second elastic members are disposed in conjunction at intervals such that their force applying points contact the edge of the LCD panel uniformly. Furthermore, the shape of the first elastic member or the second elastic member may be selected according to the frame structure. For example, the elastic member disposed at the frame notch is a flexible arm or a cantilever arm, and the elastic member disposed on the sidewall may have a slightly arched shape or a slightly rib-like shape.

In the embodiment, the frame 43 is manufactured by way of plastic injection molding, the shapes of the elastic member and the sidewall may be defined on an injection molding mold. When a plastic material is injected into this mold, the frame 43 of FIG. 2A may be formed. The elastic member is directly formed on the frame 43 without additional machining.

In addition, the invention may further be applied to the design without the notch 437. In this case, the second elastic member can be omitted.

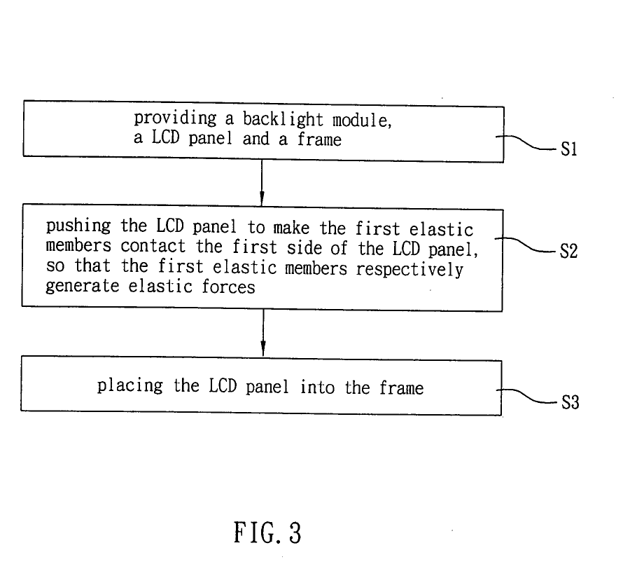

FIG. 3 is flow chart showing a method of assembling the liquid crystal display according to the preferred embodiment of the invention. Referring to FIG. 3, the method of fabricating the liquid crystal display of the image displaying system 2 of FIG. 2 includes steps S1 to S3.

First, step S1 provides the backlight module 41, the LCD panel 42 and the frame 43. In this embodiment, the backlight module 41 has been disposed in advance in the frame 43.

Then, step S2 pushes the LCD panel 42 to make the first elastic members 431a and 431b contact the first side 424 of the LCD panel 42. Thus, the first elastic members 431a and 431b respectively generate elastic forces. In addition, when the LCD panel 42 is being pushed, it is also possible to make the third side 426 of the LCD panel 42 contact the second elastic members 431c and 431d of the third sidewall 434 of the frame 43 and to make the second elastic members 431c and 431d generate elastic forces.

Finally, step S3 places the LCD panel 42 into the frame 43. The elastic forces of the first elastic members 431a and 431b push the second side 425 of the LCD panel 42 against the second sidewall 433 of the frame 43, and the elastic forces of the second elastic members 431c and 431d also push the fourth side 427 of the LCD panel 42 against the fourth sidewall 435 of the frame 43.

In addition, when the second side 425 and the fourth side 427 of the LCD panel 42 respectively contact the second sidewall 433 and the fourth sidewall 435 of the frame 43, the first positioning angle 428 of the LCD panel 42 is aligned and overlapped with the second positioning angle 436 of the frame 43. Consequently, the LCD panel 42 can be precisely disposed in the frame 43, so that the assembling tolerance between the backlight module 41 and the LCD panel 42 can be reduced.

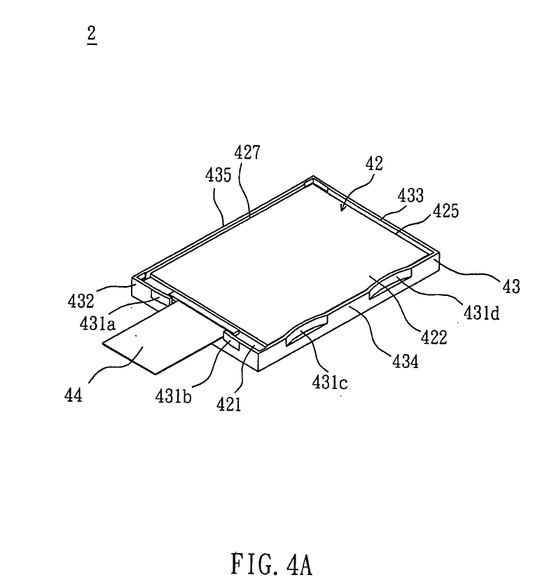

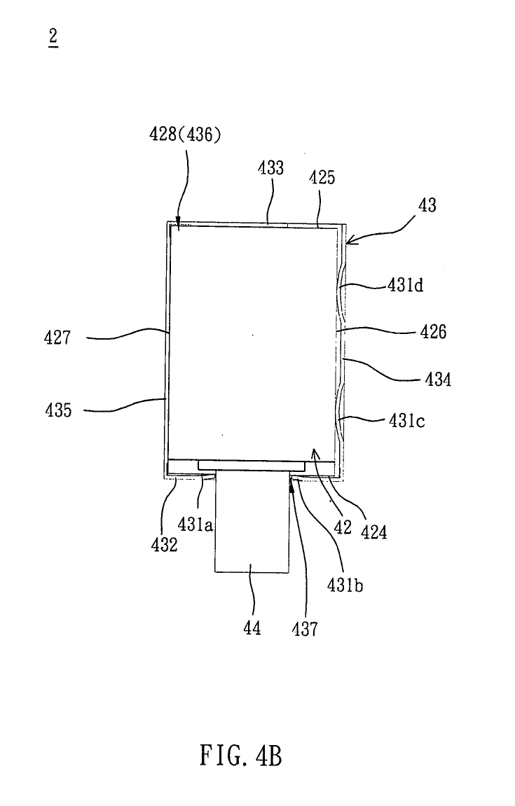

FIG. 4A is a pictorial view showing the assembled image displaying system according to the preferred embodiment of the invention. FIG. 4B is a top view showing the assembled image displaying system of FIG. 4A. As shown in FIGS. 4A and 4B, the first elastic members 431a and 431b contact the first side 424 of the LCD panel 42, and the second side 425 of the LCD panel 42 contacts the second sidewall 433 of the frame 43. The second elastic members 431c and 431d contact the third side 426 of the LCD panel 42, and the fourth side 427 of the LCD panel 42 contacts the fourth sidewall 435 of the frame 43. Consequently, the first elastic members 431a and 431b and the second elastic members 431c and 431d respectively push the LCD panel 42 to make the second side 425 and the fourth side 427 of the LCD panel 42 respectively contact the second sidewall 433 and the fourth sidewall 435 of the frame 43. If the first elastic members 431a and 431b or the second elastic members 431c and 431d have larger elastic constants, the second side 425 and the fourth side 427 of the LCD panel 42 tightly push against the second sidewall 433 and the fourth sidewall 435 of the frame 43. In addition, the positioning angle 428 of the LCD panel 42 is also aligned with and overlapping the positioning angle 436 of the frame 43 such that the effect of positioning can be surely achieved.

When the LCD panel 42 is to be disassembled from the frame 43 in a direction toward the frame, the operator only has to push the first side 424 of the LCD panel 42 toward the first elastic members 431a and 431b of the frame 43 and push the third side 426 of the LCD panel 42 toward the second elastic members 431c and 431d of the frame 43 such that the second side 425 of the LCD panel 42 is separated from the second sidewall 433 of the frame 43, and the fourth side 427 of the LCD panel 42 is separated from the fourth sidewall 435 of the frame 43. Thus, the LCD panel 42 can be taken out of the frame 43. Because these elastic members only have to be pressed during the disassembling process, in contrast with the destructive disassembly operation of the prior art, the LCD panel 42 can be separated from the frame 43 and is not damaged in the disassembly process.

Because the elastic members are disposed in the frame, the LCD panel can be directly disposed in the frame. Thus, the cost of the double-coated adhesive necessary in the prior can be saved, and the elastic members can be utilized to overlap the positioning angles of the backlight module and the LCD panel with each other such that the self-alignment effect can be achieved and the precision of assembling the LCD panel can be enhanced. In addition, when the LCD panel is to be disassembled, it suffices to press the LCD panel toward the elastic member such that each side of the LCD panel is separated from each sidewall of the frame and the LCD panel can be disassembled from the frame. Consequently, the drawbacks of damaging the LCD panel or the backlight module or the residual adhesive, which is caused by the use of the double-coated adhesive, can be avoided.

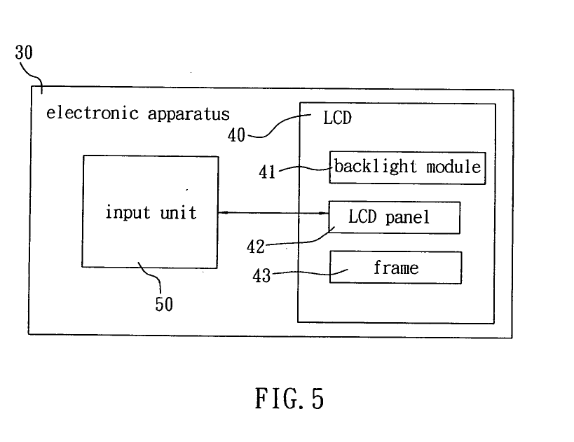

FIG. 5 is a block diagram showing the image displaying system 2 according to the preferred embodiment of the invention. Referring to FIG. 5, the image displaying system 2 has an electronic apparatus 30, which may be a mobile phone, a digital camera, a personal digital assistant, a notebook computer, a desktop computer, a television, a vehicle display or a portable digital video disk player. The backlight module 41, the LCD panel 42 and the frame 43 of this embodiment are disposed on a liquid crystal display 40, which is applied to the electronic apparatus 30. In addition, the electronic apparatus 30 further includes an input unit 50, which is electrically connected to the LCD panel 42 of the liquid crystal display 40 to enable the LCD panel 42 display an image.

In summary, because the first elastic members are disposed on the frame in the image displaying system and due to the disclosed method of fabricating the liquid crystal display according to the invention, the LCD panel can be disposed in the frame by pushing against the first elastic members or be removed from the frame by pushing the elastic members. Thus, the LCD panel may be disposed in the frame or removed from the frame in a nondestructive manner so that the problem of damaging the LCD panel when it is disassembled from the frame can be avoided. The disassembled LCD panel may also be treated as a new product or a good product for rework, such that the cost of assembling the LCD panel with the backlight module can be reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An image displaying system, comprising:
a backlight module;
a LCD (Liquid Crystal Display) panel combined with the backlight module and having a first side and a second side opposite to each other; and
a frame having a first elastic member, wherein the LCD panel is disposed in the frame, and the first side contacts the first elastic member.

2. The system according to claim 1, wherein the frame has a first sidewall and a second sidewall opposite to each other, the first elastic member is disposed on the first sidewall, and the first side and the second side of the LCD panel respectively contact the first elastic member of the frame and the second sidewall.

3. The system according to claim 2, wherein the first sidewall has a notch and the first elastic member is disposed close to the notch.

4. The system according to claim 3, further comprising:
a flexible cable, which is electrically connected to the LCD panel and passes through the notch.

5. The system according to claim 2, wherein the frame has a third sidewall and a fourth sidewall opposite to each other, and the first sidewall, the third sidewall, the second sidewall and the fourth sidewall of the frame are connected sequentially.

6. The system according to claim 5, wherein the LCD panel has a third side and a fourth side opposite to each other, and the first side, the third side, the second side and the fourth side of the LCD panel are connected sequentially.

7. The system according to claim 6, wherein the frame further comprises a second elastic member disposed in the third sidewall of the frame, and the third side and the fourth side of the LCD panel respectively contact the second elastic member and the fourth sidewall of the frame.

8. The system according to claim 6, wherein a first positioning angle is formed between the second side of the LCD panel and the fourth side of the LCD panel, a second positioning angle is formed between the second sidewall of the frame and the fourth sidewall of the frame, and the first positioning angle of the LCD panel is in alignment with the second positioning angle of the frame.

9. The system according to claim 7, wherein the first elastic member is a flexible arm.

10. The system according to claim 1, wherein the second elastic member has an arched shape.

11. The system according to claim 1, further comprising:
an electronic apparatus having the backlight module, the LCD panel, the frame and an input unit electrically connected to the LCD panel.

12. The system according to claim 11, wherein the electronic apparatus is a mobile phone, a digital camera, a personal digital assistant (PDA), a notebook computer, a desktop computer, a television, a vehicle display, or a portable digital video disk player.

13. A method of fabricating a liquid crystal display the method comprising steps of:
providing a backlight module, a LCD (Liquid Crystal Display) panel and a frame, wherein the backlight module is combined with the LCD panel, the LCD panel has a first side and a second side opposite to each other, and the frame has a first elastic member;
pushing the LCD panel to make the first elastic member contact the first side of the LCD panel to produce an elastic force; and
placing the LCD panel in the frame for enabling the elastic force of the first elastic member to push the LCD panel to make the second side of the LCD panel contact the frame.

14. The method according to claim 13, wherein the LCD panel has a first positioning angle, the frame has a second positioning angle, and the method further comprises:
aligning the first positioning angle of the LCD panel with the second positioning angle of the frame.
